(19) United States
(12) Patent Application Publication
(10) Pub. No.: US 2024/0115076 A1
(43) Pub. Date: Apr. 11, 2024

(54) OPTIMIZED THERMAL BOTTLE

(71) Applicant: PEGAF S.R.L., Reggio Di Calabria (RC) (IT)

(72) Inventor: Elvira GUALTIERI, Reggio Di Calabria (RC) (IT)

(73) Assignee: PEGAF S.R.L., Reggio Di Calabria (RC) (IT)

(21) Appl. No.: 18/554,219

(22) PCT Filed: Aug. 31, 2021
(86) PCT No.: PCT/IB2021/057946

§ 371 Date: Oct. 6, 2023

(30) Foreign Application Priority Data
Apr. 7, 2021 (IT) 102021000008594

(51) Int. Cl. A47J 41/02; A47J 41/00

(52) U.S. Cl. CPC A47J 41/028; A47J 41/0027

(57) ABSTRACT

An optimized thermal bottle, including a first compartment and a second compartment configured for containing drinks; a cap able to close the optimized thermal bottle in correspondence with an upper portion of said optimized thermal bottle. The first compartment and the second compartment are adjacent and form a thermos.

### FIELD

The present invention is related to an optimized thermal bottle.

In particular, the present invention relates to an optimized thermal bottle, of the type capable of keeping at a controlled temperature several drinks or solid foods, stored in separate compartments of the same bottle.

### BACKGROUND

The reference technical field is that of food storage, specifically liquid or solid foods stowed in containers provided with a function of thermal insulation from the external environment.

In this sense, a thermos, also known as Dewar jar, represents an effective and practical implementation of a container that keeps its contents at an almost constant temperature, without heat exchanges with the external environment, interposing with the latter some areas in which the vacuum is created, so as to allow a thermal insulation between the inner parts of the thermos and the external environment itself.

Some optimized thermal bottles are known from the prior art.

A first example of known technical solution is described by the patent application KR20200011017A whose subject is a container able to store a drink. Such a container comprises an internal portion made of a metal suitable for storing the beverage, an external portion, an insulating layer arranged between the internal and the external portion, and an opening for inserting the beverage into the container or for pouring the beverage itself. The inner surface of the basic material of the internal portion is provided with an inert metallic coating. The invention also relates to a lid comprising a locking means, able to be coupled to a complementary locking means of the container, in order to fix the lid to the container.

The patent application CN109452881A, on the other hand, describes a thermos able to adjust the temperature through solar energy, convenient to carry and which uses irradiation to absorb thermal energy useful for heating the water from low to high temperature. The thermos includes an integrated thermometer, and the temperature is adjusted, to control the heating, by means of a specific instrument. The bottle, in addition, is small and me be carried within a bag.

However, the known optimized thermal bottles are not able to independently manage several drinks or solid foods within a single container, while allowing, at the same time, to manage separately the storage temperatures of such drinks or solid foods.

### SUMMARY

The purpose of the present invention is to provide an optimized thermal bottle able to contain different drinks or solid foods separately, thus having characteristics so as to overcome the limitations that still affect the current optimized thermal bottles, with reference to the known technique.

A further purpose of the present invention is to provide an optimized thermal bottle that guarantees a thermal insulation for each of the compartments into which the bottle itself is divided, thus ensuring the storage of several drinks or solid foods at different temperatures.

According to the present invention an optimized thermal bottle is provided.

### BRIEF DESCRIPTION OF THE FIGURES

For a better understanding of the present invention, a preferred embodiment is now described, purely by way of non-limiting example, with reference to the attached drawings, in which:

FIG. 1a shows a first front view of a first embodiment of an optimized thermal bottle according to the invention;

FIG. 1b shows a second front view of a first embodiment of an optimized thermal bottle according to the invention;

FIG. 1c shows a perspective view of a cap of the optimized thermal bottle according to the invention;

FIGS. 2a, 2b and 2c show respectively a first and a second front view of a second embodiment of an optimized thermal bottle, and a perspective view of a cap of the optimized thermal bottle, according to the invention;

FIG. 2a shows a first front view of a second embodiment of an optimized thermal bottle according to the invention;

FIG. 2b shows a second front view of a second embodiment of an optimized thermal bottle according to the invention;

FIG. 3a shows a further front view of the second embodiment of the optimized thermal bottle, according to the invention;

FIG. 3b shows a further front view of the second embodiment of the optimized thermal bottle, according to the invention.

### DETAILED DESCRIPTION

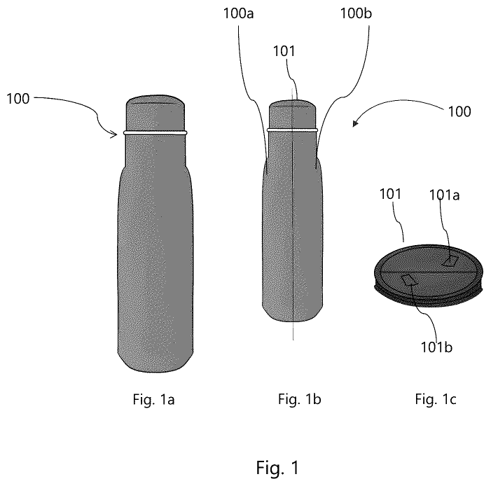

With reference to these figures and, in particular, to FIG. 1, an optimized thermal bottle is shown, according to the invention.

In particular, the optimized thermal bottle 100, 200 according to the invention comprises:
a first compartment 100a, 200a and a second compartment 100b, 200b configured for containing drinks;
a cap 101, 201 able to close the optimized thermal bottle 100, 200 in correspondence with an upper portion of said optimized thermal bottle 100, 200;

According to an aspect of the invention, the first compartment 100a, 200a and the second compartment 100b, 200b are adjacent and consist of thermos.

According to a first embodiment of the invention, the first and the second compartment 100a, 100b are adjacent and separated, inside the optimized thermal bottle 100, along a vertical plane that defines the height of the optimized thermal bottle 100 itself.

According to an aspect of the invention, in this first embodiment the cap 101 comprises a first hinged tab 101a and a second hinged tab 102a suitable, both of them configured for inserting and/or spilling drinks into and/or from the first compartment 100a and into and/or from the second compartment 100b.

Advantageously according to the invention, the aforementioned first hinged tab 101a and second hinged tab 102a allow to independently manage the capacities of the first and second compartments 101a, 101b.

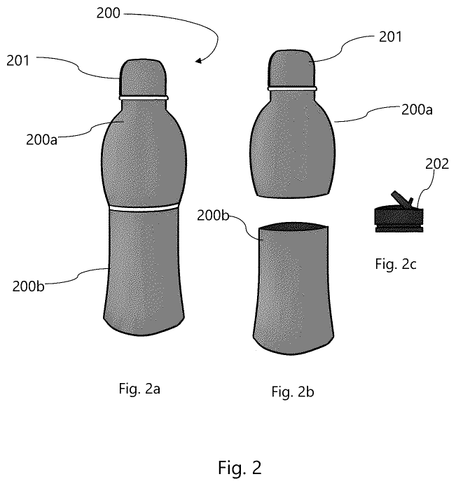

According to a second embodiment of the invention, as shown in FIG. 2, the first compartment 200a of the optimized thermal bottle 200 is overlapped to the second compartment 200b.

According to an aspect of the invention, the first compartment 200a and the second compartment 200b are able to be fixed and separated approximately in correspondence with a median plane which defines two halves of the capacity of the optimized thermal bottle 200.

According to an aspect of the invention, in the aforementioned second embodiment the first compartment 200a and the second compartment 200b, both having a closed bottom, are able to be fixed and separated by means of an interlocking system or by means of corresponding threads.

According to another aspect of the invention, the cap 201, that is able to close the first upper compartment 200a, is equipped with a hinged tab or with a screwing system to the aforementioned first compartment 200a.

According to another aspect of the invention, the optimized thermal bottle 200 comprises a further cap 202, as shown in FIG. 2c, preferably equipped with a further hinged tab, that is able to close the second compartment 200b positioned below the first compartment 200a.

According to such a second embodiment, as better shown in FIGS. 2b and 2c, the first compartment 200a and the corresponding cap 201 substantially constitute a container such as a bottle having a capacity approximately equal to half the capacity of the entire optimized thermal bottle 200, while the second compartment 200b and the corresponding cap 202 can be used, for example, as a tea holder.

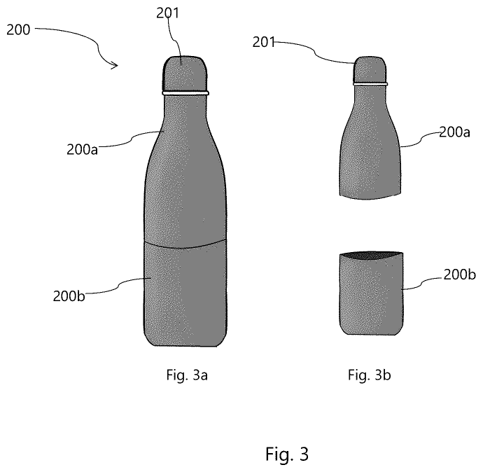

Furthermore, according to the aforementioned second embodiment, the second compartment 200b, able to be separated and fixed to the first compartment 200a by means of an interlocking system or by means of threads able to couple with corresponding threads placed over the same first compartment 200a, as shown in FIG. 3, in the absence of the cap 202 may be preferably used as a glass and/or as a container for solid foods, always having the specific properties of a thermos.

According to another aspect of the invention, the optimized thermal bottle 100, 200 may comprise more than two compartments, for example three or four compartments implemented with distinct thermos and equipped with respective closing caps, suitable for inserting and spilling similar or different drinks, or solid foods, at the same inlet temperature or at different temperatures, kept constant over time by means of the separate compartments/thermos of the optimized thermal bottle 100, 200.

According to one aspect of the invention, the optimized thermal bottle 100, 200 is made of a metallic material, preferably aluminum or stainless steel.

Therefore, the optimized thermal bottle according to the invention allows to store various drinks or solid foods, inside the bottle itself by means of separate and specific compartments.

Furthermore, the optimized thermal bottle according to the invention allows to manage the temperatures of the drinks, or solid foods, contained inside its compartments independently, thanks to the implementation of the aforementioned compartments by means of separate thermos.

Another advantage of the optimized thermal bottle according to the invention is that it is inexpensive.

Finally, the optimized thermal bottle according to the invention can be easily industrialized over a large scale.

It is finally clear that the optimized thermal bottle, described and illustrated herein, can be subject to modifications and variations without departing from the protective scope of the present invention, as defined in the appended claims.

1-8. (canceled)

9. An optimized thermal bottle, comprising:
a first compartment and a second compartment configured for containing drinks;
a cap able to close the optimized thermal bottle in correspondence with an upper portion of said optimized thermal bottle;
wherein the first compartment and the second compartment are adjacent and consist of thermos.

10. The optimized thermal bottle according to claim 9, wherein the first compartment and the second compartment are separated, inside the optimized thermal bottle, along a vertical plane that defines the height of said optimized thermal bottle.

11. The optimized thermal bottle according to claim 9, wherein the cap comprises a first hinged tab and a second hinged tab, said first hinged tab and second hinged tab being able to insert and spill drinks, respectively, from the first compartment and from the second compartment.

12. The optimized thermal bottle according to claim 9, wherein the first compartment is overlapped to the second compartment, said first compartment and second compartment being able to be fixed and separated approximately in correspondence with a median plane that defines two halves of the capacity of the optimized thermal bottle.

13. The optimized thermal bottle according to claim 12, wherein the first compartment and the second compartment are able to be fixed and separated by means of an interlocking system or by means of corresponding threads.

14. The optimized thermal bottle according to claim 12, further comprising a second cap able to close the second compartment.

15. The optimized thermal bottle according to claim 12, wherein said optimized thermal bottle is made of a metallic material.

16. The optimized thermal bottle according to claim 12, wherein the second compartment is able to be used as a glass and/or as a container of solid foods.
